(19) United States
(12) Patent Application Publication
(10) Pub. No.: US 2010/0238501 A1
(43) Pub. Date: Sep. 23, 2010

(54) Printing System, Control Method for Printing System, Print Server Machine, Control Method for Print Server Machine and Computer Program

(75) Inventor: Atsushi FUJIMAKI, Shiojiri-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/728,035

(22) Filed: Mar. 19, 2010

(30) Foreign Application Priority Data
Mar. 23, 2009 (JP) 2009-070042

(51) Int. Cl. G06F 3/12

(52) U.S. Cl. 358/1.15

(57) ABSTRACT

A printing system includes a client machine into which a printing execution instruction is input; a print server machine communicatably connected to the client machine; and a printer communicatably connected to the print server machine. The client machine includes a printer driver that creates print data in response to the input printing execution instruction and sends the print data to the print server machine; and a status monitor that sends a status request regarding the printer to the printer server machine. The print server machine includes a print server that saves the print data received from the print driver of the client machine and, in response to a predetermined trigger, sends the saved print data to the printer or another server machine for transferring the print data to the printer; and a printer status information proxy that obtains status information regarding the printer from the printer.

### CROSS-REFERENCE TO RELATED APPLICATIONS

This application claims the benefit of priority under 35 USC 119 of Japanese application no. 2009-070042, filed on Mar. 23, 2009, which is incorporated herein by reference.

### BACKGROUND

### 1. Technical Field

The present invention generally relates to a printing system or the like that receives print data from a client and performs printing of the print data. More particularly, the invention relates to a printing system, a control method for the printing system, a print server machine, a control method for the print server machine and a computer program that temporarily save print data received from a client in a server, and subsequently, upon receiving a predetermined trigger such as authentication of a user or input of a user password, initiate printing, in other words, perform a function known as authentication printing, password printing, or the like.

In JP-A-2008-242851, a printing system is disclosed that has an authentication printing function. Print data for normal printing is directly sent to a printer from a client. However, print data for authentication printing is sent to a print server from a client and is saved in the print server. Once personal authentication of a user has been performed, the print server then transfers the print data to the printer and the printer performs printing in accordance with the print data.

Generally, together with a printer driver that creates print data, a status monitor that monitors the status of a printer is also installed in the client. The status monitor usually communicates with a printer that has been specified as a printer that will perform printing (usually a printer that corresponds to the printer driver selected by the user) and checks the status of the printer by obtaining values of an MIB (management information base) of the printer (hereafter, printer MIB).

In relation to such status monitors, a technique of distributing processing for monitoring the status of a printer and processing for controlling a printer and input/output of data by using a simple configuration is disclosed in JP-A-2008-176401. Furthermore, a technique for ensuring that a user can easily recognize that a certain functional restriction has been set in a printer is disclosed in JP-A-2004-94350.

In the case of authentication printing or password printing, a client treats a print server, which saves print data therein, as a virtual printer, which will not actually perform printing of print data, and sends print data to the print server. Control of sending the print data to the printer that will actually perform printing of the print data is then entrusted to the print server and the client does not need to perform such control after sending the print data to the print server.

At such a time, the status monitor of the client attempts to obtain the values of the MIB from the print server. However, since the printer MIB for the printer that actually performs the printing is not stored in the print server, the values of the MIB cannot be obtained. Therefore, the user cannot learn the status of the printer.

### SUMMARY

An advantage of some aspects of the invention is that, even in the case where a client treats a print server as a virtual printer that will not actually perform printing and is a different apparatus from the printer that will actually perform printing, and sends print data to the print server, as in authentication printing and password printing, it is ensured that the client can check the status of the printer.

In order to achieve the above advantage, according to a first aspect of the invention, a printing system includes a client machine into which a printing execution instruction is input by a user; a print server machine that is communicatably connected to the client machine; and a printer that is communicatably connected to the print server machine. The client machine includes a printer driver that receives the input printing execution instruction, creates print data and sends the print data to the print server machine; and a status monitor that sends a status request regarding the printer to the printer server machine. The print server machine includes a print server that saves the print data received from the print driver of the client machine, and then, in response to a predetermined trigger, sends the saved print data to the printer or another server machine for transferring the print data to the printer; and a printer status information proxy that obtains status information regarding the printer from the printer and, in response to the status request from the status monitor, sends the obtained status information to the status monitor.

According to the printing system of the first aspect, when the printer status information proxy of the print server machine obtains status information regarding the printer from the printer and then receives a status request from the status monitor of the client machine, the printer status information proxy of the print server machine sends the obtained printer status information to the status monitor of the client machine. Therefore, the client machine treats the print server machine as a virtual printer and can learn the status of the printer even though the client machine communicates with only the print server machine. The client machine does not need to communicate with the printer, as in the related art.

In this printing system, after the printer status information proxy of the printer client machine has received a status request from the status monitor, the printer status information proxy may obtain the printer status information regarding the printer from the printer and send the printer status information to the status monitor. Alternatively, the printer status information proxy may obtain printer status information regarding the printer from the printer and store the obtained printer status information, prior to receiving a status request from the status monitor. Then, upon receiving a status request, the printer status information proxy may send the stored printer status information to the status monitor.

In one embodiment, values of the printer MIB possessed by the printer are used as the status information regarding the printer.

In another embodiment, in the case where the user has been authenticated, a print data request that specifies certain print data of the user and that is sent to the print server machine from the printer or other server machine is used as the predetermined trigger. Upon receiving the print data request, the print server machine selects the print data specified by the request from among the saved print data and sends the selected print data to the printer or the other server machine. In short, this is an example of authentication printing or password printing. When this type of printing is performed, the client machine can learn the status of the printer by just communicating with only the print server machine.

A second aspect of the invention is a method of operating a printing system that includes a client machine into which a printing execution instruction is input by a user; a print server machine that is communicatably connected to the client machine; and a printer that is communicatably connected to the print server machine. The method includes creating print data in response to the input printing execution instruction and sending the print data to the print server machine by using the client machine; sending a status request regarding the printer to the print server machine by using the client machine; receiving the print data from the client machine and saving the received print data by using the print server machine; sending, in response to a predetermined trigger, the saved print data to the printer or another server machine for transferring the print data to the printer by using the print server machine; obtaining status information regarding the printer from the printer by using the print server machine; and sending, in response to a status request from the client machine, the obtained status information regarding the printer to the status monitor by using the print server machine.

A third aspect of the invention is a print server machine that is communicatably connected to a client machine that outputs print data and a status request and to a printer that performs printing on the basis of the print data. The print server machine includes a print server that receives the print data from the client machine, saves the received print data, and then, in response to a predetermined trigger, sends the saved print data to the printer or to another server machine for transferring the print data to the printer; and a printer status information proxy that receives status information regarding the printer from the printer, and, in response to a status request from a status monitor of the client machine, sends the obtained status information to the status monitor.

A fourth aspect of the invention is a method of operating a print server machine that is communicatably connected to a client machine that outputs print data and a status request and to a printer that performs printing on the basis of the print data. The method includes receiving the print data from the client machine and saving the received print data; sending, in response to a predetermined trigger, the saved print data to the printer or to another print server for transferring print data to the printer; obtaining status information regarding the printer from the printer; and receiving the status request from the client machine and sending the obtained status information to a status monitor.

A fifth aspect of the invention is a computer program for causing a method of operating a print server machine that is communicatably connected to a client machine that outputs print data and a status request and to a printer that performs printing on the basis of the print data to be executed in a computer. The method of operating the print server machine includes receiving the print data from the client machine and saving the received print data; sending, in response to a predetermined trigger, the saved print data to the printer or to another server machine for transferring print data to the printer; obtaining status information regarding the printer from the printer; and receiving the status request from the client machine and sending the obtained status information to a status monitor.

According to the invention, even when the client machine communicates with only the print server machine and does not directly communicate with the printer, the client machine can still learn the status of the printer. A status monitor having the same function as a status monitor of the related art can be used as the status monitor of the client machine.

### BRIEF DESCRIPTION OF THE DRAWINGS

The invention will be described with reference to the accompanying drawings, wherein like numbers reference like elements.

FIG. 1 is a block diagram illustrating a configuration of and the flow of processing of a printing system according to a first embodiment of the invention.

FIG. 2 is a flowchart of processing performed in the printing system of FIG. 1 in which a printer MIB proxy returns values of a printer MIB in response to a request from a client PC.

FIG. 3 is a flowchart of processing in which the printer MIB proxy periodically sends the printer MIB to the client PC, the flow being a modification of the flow of FIG. 2.

FIG. 4 is a flowchart of processing in which the flowchart of FIG. 3 continues to step 13.

FIG. 5 is a block diagram illustrating a configuration of and the flow of processing of a printing system according to a second embodiment of the invention.

### DESCRIPTION OF EXEMPLARY EMBODIMENTS

Embodiments of a printing system according to the invention are now described. In each of the embodiments, like elements are denoted by like reference numerals.

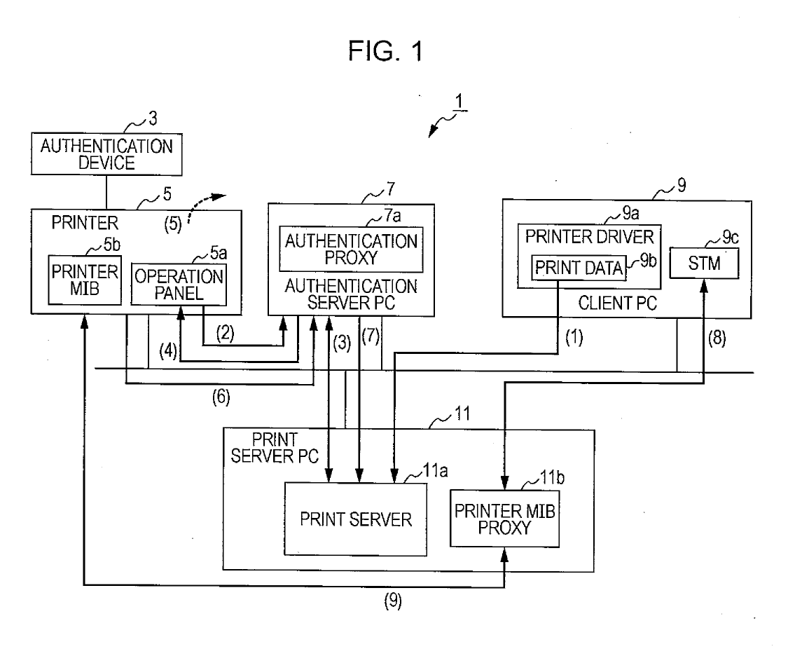

First, a printing system according to a first embodiment of the invention will be described. FIG. 1 is a block diagram illustrating a configuration of and the flow of processing of a printing system 1 according to the first embodiment of the invention. The printing system 1 includes a printer 5, a personal computer 7 functioning as an authentication server machine, (“authentication server PC”), a personal computer 9 functioning as a client machine (“client PC”), and a personal computer 11 serving as a print server machine (“print server PC”). The printer 5, authentication server PC 7, the client PC 9 and the print server PC 11 are connected to a communication network. In order to carry out functions of the invention, the printer 5, the authentication server PC 7 and the print server PC 11 are capable of two-way communication with one another, and the client PC 9 and the print server PC 11 are capable of two-way communication with each other.

An authentication device 3 that reads personal authentication information (user ID, password, and/or name, etc.) of a user from an ID card or the like possessed by the user of the client PC 9 is connected to the printer 5. Once the user has set his/her own ID card in the authentication device 3, the printer 5 is able to obtain authentication information of the user. The printer 5 includes an operation panel 5a having a set of input keys to be operated by the user, a display screen; a printer MIB 5b storing a variety of information relating to the printer 5, including information regarding the status of the printer 5; and a print engine that performs print processing on the basis of print data.

The authentication server PC 7 includes an authentication proxy 7a, which is a type of computer program. The authentication proxy 7a is executed by the authentication server PC 7 in order to perform user authentication processing to determine whether a user is a valid user by using authentication information of users obtained by the printer 5. In the case where the user is authenticated, the print data of the user is transferred from within the print server machine 11 to the printer 5.

The client PC 9 includes the following kinds of computer programs: a printer driver 9a, a status monitor (“STM”) 9c, and an application program that processes files that are units of print data. The client PC 9 also includes an input device allowing a user to input printing instructions and the like. The printer driver 9a is a computer program for performing authentication printing in the printing system 1. After the printer driver 9a is initiated by an operation performed by a user, in response to a printing execution instruction input by the user, the printer driver 9a creates print data 9b for authentication printing on the basis of a file specified by the user and then sends the print data 9b to the print server PC 11. In other words, the printer driver 9a treats the print server PC 11 as a virtual printer that will perform authentication printing. When a status request has been input by the user or when a predetermined event occurs such as initiation of the printer driver 9a, the STM 9c sends a status request concerning the printer 5 to the print server PC 11 (that is, a machine that is the same as the machine being treated as the virtual printer that will perform authentication printing, in other words, a machine that is the same as a machine in which print server 11a operates).

The print server PC 11 includes the print server 11a and a printer MIB proxy 11b, both of which are kinds of computer programs. The print server 11a receives the print data 9b from the printer driver 9a of client PC 9 and saves the print data 9b in the print server 11a. When the print server 11a receives a print data request specifying certain print data from the authentication proxy 7a of the authentication server PC 7, the print server 11a selects the print data specified by the print request from among print data saved in the print server PC 11 and then sends the selected print data to the authentication proxy 7a. In addition, the printer MIB proxy 11b obtains values relating to status information regarding the printer 5 from within the printer MIB 5b and then when the printer MIB proxy 11b receives a status request from the STM 9c of the client PC 9, the printer MIB proxy 11b sends the obtained values of the printer MIS 5b to the STM 9c.

The flow of authentication printing processing performed in the printing system 1 of FIG. 1 is now described.

First, the user inputs a printing execution instruction to the printer driver 9a of the client PC 9 and as a result the printer driver 9a creates and outputs the print data 9b for authentication printing. The client PC 9 sends the print data 9b to the print server 11a of the print server PC 11, as illustrated by arrow (1). The print server 11a receives and saves the print data 9b in the print server PC 11.

Next, the user goes to the location of the printer 5 and sets a recording medium on which his or her authentication information is stored, for example, his or her ID card, in the authentication device 3 connected to the printer 5. The user operates the operation panel 5a of the printer 5, and thereby the printing mode of the printer 5 is set to an authentication printing mode. The authentication device 3 reads the authentication information of the user from the recording medium set therein and sends the authentication information to the printer 5. The printer 5 sends an authentication printing initiation command including the authentication information of the user to the authentication proxy 7a of the authentication server PC 7 as illustrated by arrow (2).

In response to the authentication printing initiation command, the authentication proxy 7a of the authentication server PC 7 performs authentication processing for the user by using the authentication information included in the command. As a result, provided that the user is authenticated, the authentication proxy 7a establishes a connection with the print server 11a of the print server PC 11, as illustrated by arrow (3), and finds out the number of pieces of print data (print jobs) of the user saved in the print server 11a and then informs the printer 5 of the number of print jobs as illustrated by arrow (4). The printer 5 having been informed of the number of authentication print jobs by the authentication proxy 7a, displays the number of authentication print jobs on the operation panel 5a of the printer 5.

Next, when the user instructs initiation of the authentication print job by operating the operation panel 5a, the printer 5 sends an authentication print job initiation command to the authentication proxy 7a as illustrated by arrow (2). In response to the authentication print job initiation command, the authentication proxy 7a establishes a connection with the print server 11a and makes a request to the print server 11a for print data of the user as illustrated by arrow (3). Upon receiving the request, the print server 11a selects the print data of the user from among print data saved therein, and, as illustrated by arrow (3), sends the selected print data of the user to the authentication proxy 7a.

The authentication proxy 7a of the authentication server PC 7 then sends the print data received from the print server 11a to the print server port of the printer 5, as illustrated by arrow (4).

The printer 5 executes the print job on the basis of the print data received from the authentication proxy 7a, as illustrated by arrow (5). Together with this, the printer 5 performs control to associate the print job corresponding to the print data with property information that indicates the fact that the print job is an “authentication print job”.

Next, the printer 5 specifies the print job that is currently being executed from among print jobs being managed therein and then checks whether the specified print job is complete. When it is confirmed that the print job is complete, the printer 5 determines whether or not the completed print job is an “authentication print job” on the basis of the property information associated with the print job. If the completed print job is an “authentication print job”, the printer 5 informs the authentication proxy 7a of the authentication server PC 7 of the completion of the print job, as illustrated by arrow (6).

Having been informed of the completion of the print job, the authentication proxy 7a sends a notification to the print server 11a of the print server PC 11 to identify the print job that has now been completed. In response, the print server 11a deletes the print data corresponding to the print job from among the saved print data.

In the above description, only authentication printing is focused upon. In addition to authentication printing, the following operation for enabling the client PC 9 to grasp status information regarding the printer is also performed.

At a predetermined timing (for example, when a print execution instruction has been input to the printer driver 9a in the client PC 9, when the user has initiated the STM 9c through the printer properties screen of the printer driver 9a, or the like), the STM 9c of the client PC 9 makes a request for values of the printer MIB to the printer MIB proxy 11b of the server machine, which is a machine in which the print server 11a is operating (that is, the print server PC 11), as illustrated by arrow (8).

Upon receiving this request, the printer MIB proxy 11b obtains values of the printer MIB 5b of the printer 5 from the printer 5 (the printer 5 is set in advance as a printer in the printer MIB proxy 11b, before values of the printer MIB 5b are obtained), as illustrated by arrow (9). At this time, the obtained values of the printer MIB 5b need not be all the values stored in the printer MIB 5b, but rather may be values within a range necessary to grasp the printer status information. The printer MIB proxy 11b then sends the values of the printer MIB 5b obtained from the printer 5 to the STM 9c of the client PC 9. The STM 9c of the client PC 9 learns the status of the printer 5 (for example, the status in terms of paper, amount of toner, errors, and the like) on the basis of the values of the printer MIS 5b received from the printer MIS proxy 11b, and accordingly performs control (for example, informs the user of the learned status or the like).

In this way, the client PC 9 can obtain status information regarding the printer from the STM 9c in the case of various types of printing in which the client PC 9 does not directly communicate with the printer, such as in authentication printing and password printing. At such a time, basically, an STM having the same specification as a known STM can be used as the STM 9c of the client PC 9.

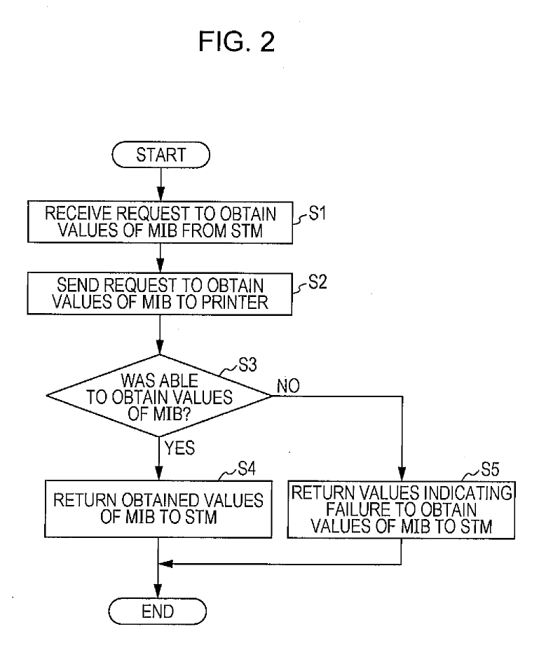

FIG. 2 illustrates the flow of one example of processing performed in the printing system 1 of FIG. 1, in which the printer MIB proxy 11b obtains values of the printer MIB 5b from the printer 5 and sends the obtained values to the client PC 9.

As illustrated in FIG. 2, the printer MIB proxy 11b of the print server PC 11 receives a request to obtain the printer MIB 5b (request to obtain status information) from the STM 9c of the client PC 9 (step S1). The printer MIB proxy lib then sends a request to obtain values of the printer MIB 5b to the printer 5 (step S2).

Next, if the printer MIB proxy 11b was able to obtain the values of the printer MIS 5b as a result of step S2 (YES in step S3), the printer MIB proxy 11b returns the obtained values of the printer MIB 5b to the STM 9c of the client PC 9 (step S4).

On the other hand, if the printer MIB proxy 11b could not obtain the values of the printer MIB 5b (NO in step S3), the printer MIB proxy 11b returns values indicating failure to obtain the printer MIB 5b to the STM 9c of the client PC 9 (step S5).

In this way, in response to the request from the STM 9c, the printer MIB proxy 11b both obtains values of the printer MIB 5b from the printer 5 and returns the values to the STM 9c of the client PC 9.

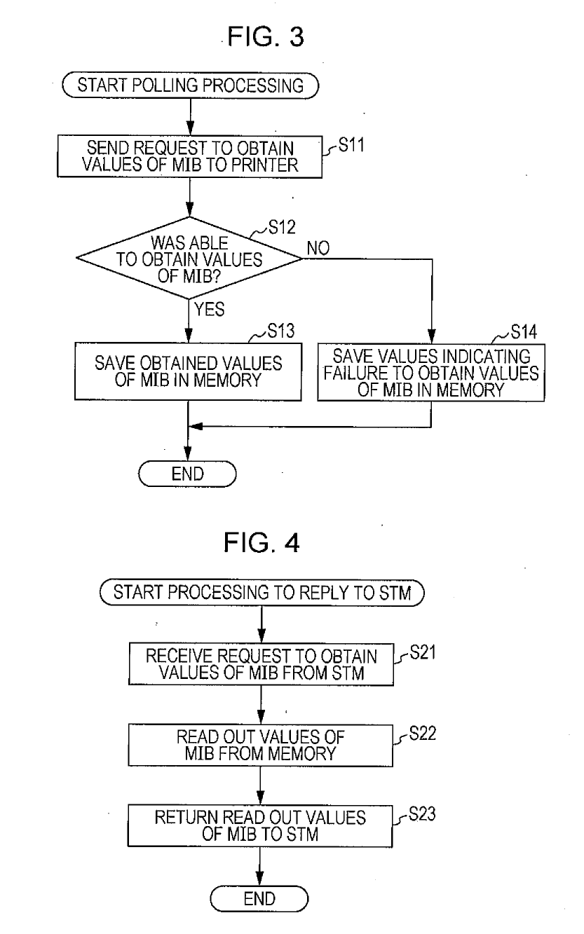

FIGS. 3 and 4 illustrate modified processing flows in which the printer MIB proxy 11b obtains values of the printer MIB 5b from the printer 5 and sends the values to the client PC 9.

In the flow of FIG. 3, at a predetermined timing other than a timing at which a request to obtain values of the printer MIB 5b is received from the STM 9c, processing is performed to obtain values of the printer MIB 5b from the printer 5.

As illustrated in FIG. 3, the printer MIB proxy 11b of the print server PC 11 initiates polling processing to poll the printer S at a predetermined timing (for example, at the time of occurrence of a predetermined event such as when print data is received, and/or at times that periodically arrive at predetermined intervals) and sends a request to obtain values of the printer MIB 5b to the printer 5 (step S11).

As a result of step S11, if values of the printer MIB 5b could be obtained (YES in step S12), the printer MIB proxy 11b saves the obtained values of the printer MIB 5b in the memory of the printer MIB proxy 11b (step S13). On the other hand, if values of the printer MIB 5b could not be obtained (NO in step S12), the printer MIB proxy 11b saves values indicating failure to obtain values of the printer MIB 5b in the memory of the printer MIB proxy 11b (step S14).

In addition to the control illustrated in FIG. 3, the printer MIB proxy 11b also performs the control illustrated in FIG. 4.

In FIG. 4, when the printer MIB proxy 11b receives a request to obtain the printer MIB 5b from the STM 9c of the client PC 9 (step S21), the printer MIB proxy 11b reads out values of the printer MIB 5b (or values indicating failure to obtain the printer MIB 5b) saved in advance from the memory in relation to the control illustrated in FIG. 3 (step S22) and returns the read out values to the STM 9c of the client PC 9 (step S23).

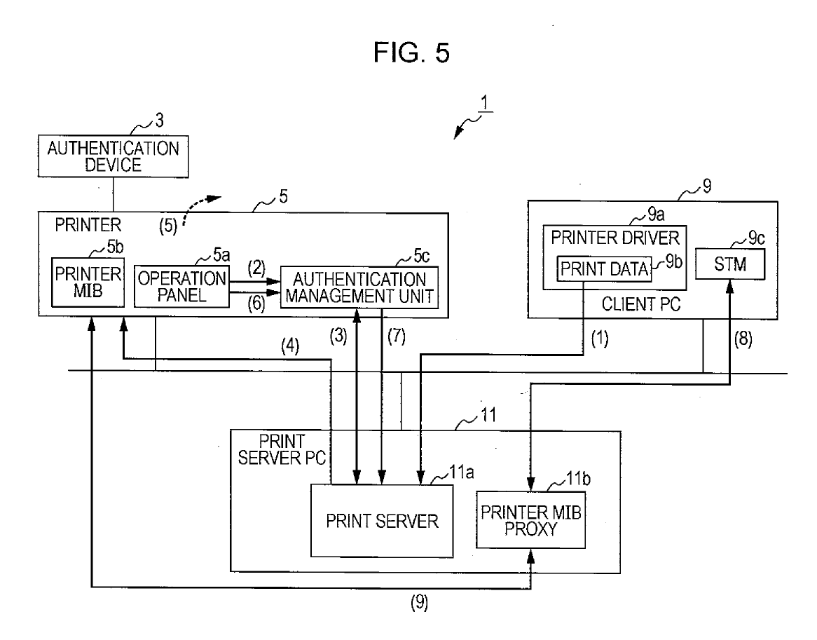

A printing system according to a second embodiment of the invention is now described. FIG. 5 is a block diagram illustrating a configuration of and the flow of processing of the printing system according to the second embodiment.

The following are the main points of difference between the printing systems of FIGS. 1 and 5. In contrast to the printing system 1 of FIG. 1, there is no authentication server PC 7 (authentication proxy 7a) in the printing system of FIG. 5. Instead the printer 5 has an authentication management unit 5c that performs control substantially the same as that performed by the authentication server PC 7 (authentication proxy 7a) of FIG. 1.

The flow of operations of authentication printing in the printing system of FIG. 5 can be explained by replacing the term “authentication server PC 7 (authentication proxy 7a)” used in the description of the operation of the printing system of FIG. 1 with the term “authentication management unit 5c”.

The embodiments of the invention described above are just illustrative examples for explaining modes of the invention, and the scope of the invention is not limited to these embodiments.

What is claimed is:

1. A printing system comprising:
a client machine into which a printing execution instruction is input by a user;
a print server machine that is communicatably connected to the client machine; and
a printer that is communicatably connected to the print server machine;
wherein the client machine includes
a printer driver that creates print data in response to the input printing execution instruction and sends the print data to the print server machine;
and a status monitor that sends a status request regarding the printer to the printer server machine; and
wherein the print server machine includes
a print server that saves the print data received from the print driver of the client machine, and then, in response to a predetermined trigger, sends the saved print data to the printer or another server machine for transferring the print data to the printer; and
a printer status information proxy that obtains status information regarding the printer from the printer and, in response to the status request from the status monitor, sends the obtained status information to the status monitor.

2. The printing system according to claim 1,
wherein when the printer status information proxy receives the status request from the status monitor, the printer status information proxy obtains the status information regarding the printer from the printer and sends the obtained status information to the status monitor.

3. The printing system according to claim 1,
wherein, before receiving the status request from the status monitor, the printer status information proxy obtains and stores the status information regarding the printer from the printer, and when the status request from the status monitor is received, the printer status information proxy sends the stored status information to the status monitor.

4. The printing system according to claim 1,
wherein the printer status information proxy receives values of a printer MIB possessed by the printer from the printer as the status information regarding the printer.

5. The printing system according to claim 1,
wherein the print server machine receives a print data request specifying certain print data from the printer or the other server machine as the predetermined trigger, selects the specified print data from among the saved print data and sends the selected print data to the printer or the other server machine.

6. A method of operating a printing system that includes a client machine into which a printing execution instruction is input by a user; a print server machine that is communicatably connected to the client machine; and a printer that is communicatably connected to the print server machine; the method comprising:
creating print data in response to the input printing execution instruction and sending the print data to the print server machine by using the client machine;
sending a status request regarding the printer to the print server machine by using the client machine;
receiving the print data from the client machine and saving the received print data by using the print server machine;
sending, in response to a predetermined trigger, the saved print data to the printer or another server machine for transferring the print data to the printer by using the print server machine;
obtaining status information regarding the printer from the printer by using the print server machine; and
sending, in response to the status request from the client machine, the obtained status information regarding the printer to the status monitor by using the print server machine.

7. A print server machine that is communicatably connected to a client machine that outputs print data and a status request and to a printer that performs printing on the basis of the print data, the print server machine comprising:
a print server that receives the print data from the client machine, saves the received print data, and then, in response to a predetermined trigger, sends the saved print data to the printer or to another server machine for transferring the print data to the printer; and
a printer status information proxy that receives status information regarding the printer from the printer, and, in response to a status request from a status monitor of the client machine, sends the obtained status information to the status monitor.

8. A method of operating a print server machine that is communicatably connected to a client machine that outputs print data and a status request and to a printer that performs printing on the basis of the print data, the method comprising:
receiving the print data from the client machine and saving the received print data;
sending, in response to a predetermined trigger, the saved print data to the printer or to another print server for transferring print data to the printer;
obtaining status information regarding the printer from the printer; and
receiving the status request from the client machine and sending the obtained status information to a status monitor.

9. A computer-readable recording medium that stores a computer program for causing a method of operating print server machine that is communicatably connected to a client machine that outputs print data and a status request and to a printer that performs printing on the basis of the print data to be executed in a computer, the method including:
receiving the print data from the client machine and saving the received print data;
sending, in response to a predetermined trigger, the saved print data to the printer or to another server machine for transferring print data to the printer;
obtaining status information regarding the printer from the printer; and
receiving the status request from the client machine and sending the obtained status information to a status monitor.
